(19) United States
(12) Patent Application Publication
(10) Pub. No.: US 2016/0210874 A1
(43) Pub. Date: Jul. 21, 2016

(54) SYSTEM AND METHOD FOR INCREASING LEARNING THROUGH EATING PROTEIN, EXERCISING, AND SINGING AND PREVENTING BULLYING

(71) Applicant: Michele Lucien Erickson, Palm Desert, CA (US)

(72) Inventor: Michele Lucien Erickson, Palm Desert, CA (US)

(21) Appl. No.: 14/914,242

(22) PCT Filed: Sep. 24, 2014
(86) PCT No.: PCT/US2014/057304

§ 371 Date: Feb. 24, 2016

Related U.S. Application Data
(60) Provisional application No. 61/884,783, filed on Sep. 30, 2013.

(51) Int. Cl. G09B 19/00; G09B 5/02

(52) U.S. Cl. CPC G09B 19/00; G09B 5/02

(57) ABSTRACT

A system and method of enhancing learning through a combination exercising, singing, and eating protein is provided. The method includes the steps of exercising in place for five minutes, singing a song, sitting in silence, eating the protein-based food, and commencing a teaching or training session. The system includes providing a protein based food, an exercise regime, and at least one song, then implementing a combination of exercising using the regime, singing the at least one song and eating the protein-based food, including: exercising in place, singing a song, sitting in silence, eating the protein-based fond, and commencing a teaching or training session.

### CROSS REFERENCE TO RELATED APPLICATION

This application claims the benefit under 35 U.S.C. §119(e) to U.S. Provisional Application No. 61/884,783 filed on Sep. 30, 2013, which application is incorporated by reference herein in its entirety.

### BACKGROUND

1. Technical Field

The present disclosure is directed to teaching and learning methodologies and, more particularly, to an educational program that enhances intellectual development through a combination of diet, physical fitness, silent meditation, and vocal expression through music as well as provides anti-bullying education.

2. Description of the Related Scientific Techniques

Substantial research has been performed in the areas of nutrition, exercise, and music as it relates to intellectual development. However, little to no research has been done on how exercise, music, silent meditation, and nutrition can be combined to enhance the learning process.

### BRIEF SUMMARY

The present disclosure is directed to a system and method to increase learning by combining an exercise regime with singing, a dietary intake of protein, and silent meditation as described herein.

In accordance with another aspect of the present disclosure, a method is provided that includes the steps of exercising in place for five minutes, singing a song, sitting in silence, eating the protein-based food, and commencing a teaching or training session.

In accordance with a further aspect of the present disclosure, the system includes providing an exercise regime, at least one song, and a protein based food, then implementing a combination of exercising using the regime, singing the at least one song, and eating the protein-based food, which includes: exercising in place, preferably for five minutes, singing a song, preferably for at least three minutes, sitting in silence, preferably for at least one minute, followed by eating the protein-based food, preferably for at least five minutes, and then commencing a teaching or training session.

In accordance with another aspect of the present disclosure, a program for preventing bullying through anti-bullying education is provided. This anti-bullying program can be used alone or in combination with the system and method to increase learning by combining an exercise regime with singing and a dietary intake of protein as described herein.

In accordance with a further aspect of the present disclosure, a system is provided that is directed to educating students. In one representative implementation, the system includes a protein based food, an exercise regime, at least one song, instructions for implementing a combination of eating the protein-based food, exercising using the exercise regime, and singing the at least one song. The system includes instructions for exercising in place for five minutes, singing the song, sitting in silence; and eating the protein-based food, and a workbook comprising exercises that aid students in developing self-identity, self-esteem, and that helps students to recognize common traits with other students, as described above. The instructions and the workbook may be provided in paper form or in a digital format, such as on a CD-ROM, DVD, or over a network of computers.

### BRIEF DESCRIPTION OF THE SEVERAL VIEWS OF THE DRAWINGS

The foregoing and other features and advantages of the present disclosure will be more readily appreciated as the same become better understood from the accompanying drawings when taken in conjunction with the detailed description that follows, wherein:

FIG. 1 is a flow chart illustrating the implementation of the learning methodology of the present disclosure.

### DETAILED DESCRIPTION

In the following description, certain specific details are set forth in order to provide a thorough understanding of various disclosed embodiments. However, one skilled in the relevant scientific techniques will recognize that embodiments may be practiced without one or more of these specific details, or with other methods, components, materials, etc. In other instances, well-known structures or components or both associated with exercise physiology, composition and performance of musical numbers, and protein-based foods have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments. For ease of reference, similar structures and features will be illustrated and described using the same reference number.

### Research to Explain How Exercise Benefits Learning and Memory

Dartmouth: “Researchers Are Learning How Exercise Affects The Brain” by David Bucci, Associate Professor in the Department of Psychological and Brain Sciences and teams of graduate and undergraduates.

David Bucci: “Exercise clears the mind. It gets the blood pumping and more oxygen is delivered to the brain.” They investigated a mechanism through which exercise seems to improve learning and memory. This is “brain derived neurotrophic factor” (BNDF) and its involved with growth of developing the brain. The degree of BDNF expression in exercising rats correlated positively with improved memory, and exercising as an adolescent had longer lasting effects compared to the same duration of exercise, but done as an adult.

One of the findings of this study included that the effects of exercise are different on memory as well as on the brain, depending on whether the exerciser is an adolescent or an adult. “The implication is that exercising during development, as your brain is growing, is changing the brain in concert with normal developmental changes, resulting in your having more permanent wiring of the brain in support of things like learning and memory,” says Bucci. “It seems important to [exercise] early in life.”

Anecdotal evidence from colleagues at the University of Vermont started Bucci down the track of ADHD. Based on observations of ADHD children in Vermont summer camps, athletes or team sports players were found to respond better to behavioral interventions than more sedentary children. While systematic empirical data is lacking, this association of exercise with a reduction of characteristic ADHD behaviors was persuasive enough for Bucci.

Early on, laboratory rats that exhibit ADHD-like behavior demonstrated that exercise was able to reduce the extent of these behaviors.

Prevention Magazine, April 2013, Pg. 8

If fatigued . . . move for more energy. . . . exercising at a low or moderated intensity three times a week, can help you beat fatigue by increasing energy levels by 20%, according to researchers at the University of Georgia. Whether you're leaping and bounding in the early AM . . . boosts spirits . . .

Harvard Health Letter, Volume 37, Number 5, “Putting more Brain in the Bank”

Exercise, a brain booster. Physical activity may be just as important as mental activity for brain health and building up cognitive reserve . . . and aerobic exercise that gets your heart rate up may be especially important.

Exercise seems to affect the brain directly, increasing the number of synapses and enhancing the action of neurotransmitters, the chemicals that make brain cell to brain cell communication possible. It also increases the production of brain-derived neutrotrophic factor (BDNF), a “brain juice” protein that promotes the production of new brain cells and the survival of existing ones.

### Research to Explain How Singing Benefits Learning and Memory

CNN, Monday May 28, 2012 By Elizabeth Landau. “Music: It's in your head, changing your brain.”

Music helps kids remember basic facts, such as the order of letters in the alphabet. Partly because songs tap into fundamental systems in our brains that are sensitive to melody and beat . . . Today, we still use songs to teach children things in school, like the 50 states.”

“I think there's enough evidence to say that musical experience, musical exposure and musical training change your brain,” says Dr. Charles Lamb, Associate Professor of Otolaryngology and head and neck surgery at John Hopkins University. “It allows you to think in a way that you used to not think, and it also trains a lot of cognitive facilities that have nothing to do with music . . . ”

Learning how to sing is similar to learning how to play an instrument. “When you sit down at the piano and learn how to play a song, your brain has to execute what's known as a “motor-action plan.” It means that a sequence of events must unfold in a particular order, your fingers must hit a precise pattern of notes in order. And you rehearse those motor movements over and over, strengthening the neural circuits the more you practice . . . Even though it feels like it's in your fingers, it's not.” Levitin said. The brain has a certain number of entry nodes in the motor-action plan . . . ”It's in the finger representation in your head.

Music and Pleasure. Music is strongly associated with the brain's reward system. It's the part of the brain that tells us if things are valuable, or important or relevant to survival, said Robert Zatorre, professor of neurology and neurosurgery at Montreal Neurological Institute.

One brain structure in particular, called the striatum, releases a chemical called dopamine in response to pleasure—related stimuli. Imaging of the brain can reveal this process is similar to what happens in your brain in response to food or sex.

Dopamine is released from a different brain area (the dorsal striatum) about 10 to 15 seconds before the peak pleasure.

The reason this occurs is that the brain likes to investigate its environment and figure out what's coming next. As you're anticipating a moment of pleasure, you're making predictions about what you're hearing and what you're about to hear,” he said. “Part of the pleasure we derive from it is being able to make predictions. Neuroscientists believe there's basically one pleasure mechanism, and music is one route into it.

“Some people have theorized that that was the original function of this behavior in evolution: It was a way of bonding people emotionally together in groups, through shared movement and shared experience.” Patel said.

Music as mood changing: “Listen to something that makes you energetic at the beginning of the day, and listen to a soothing song after argument, Levitin says.

### The Role Singing Plays in Learning

Orator: Felicia Dobbs, vocal professor at Pacific Lutheran University,

Western Washington University and Shoreline Community College. She has been invited to teach and conduct master classes while performing in Japan, and is frequently called upon as an adjudicator. Felicia's vocal training includes studies at the San Francisco Conservatory, Hochschule for Musik and Darstellende Kunst in Frankfurt, Germany, the Mozarteum in Salzberg, Austria, and study with master teachers in Europe and the U.S. Adjunct training has included dance, stage movement, breath therapy, yoga and the Alexander Technique. She's a current member of National Association of Teachers of Singing (NATS) and past President.

“Singing's a better visceral experience, getting more oxygen, taking deeper breaths, in a decent posture blood supply is better. This energy enlightens the brain when singing a song. Emotional part—using feeling as an emotion [evokes] good emotions and is a very positive experience . . . feeling lively and fun or joy. It's a learning process in itself. It enhances that individual for further learning.”

“Vibrations in the bones, resonance—vibration and tone. Toning to help people in stress. Certain instruments you can feel within your own body.”

“ADHD and Autistic children are benefitted; they are open and very freeing [after singing]. For all children, singing builds self-esteem; they're learning, enjoying and accomplishing. Feeling joy, singing is an endorphin boost; it creates happy and calming children. It's a self-discovery for them, they don't know what they're going to discover.

There is also a physical and mental part to this—a wow! Letting go of fear.”

“Group Singing: When singing with a group, there's a sense of feeling more confident, not having to be singled out. In a group, children may not pull back, not taking a bigger breath due to fear.”

Autistic kids who don't communicate can feel the music and learn. A study from Japan sites a group of autistic kids who were part of a jazz band. The children played pieces of Jazz music. They increased their ability to learn and play the horns, drums, guitar, bass and also learned to communicate with one another while learning to play these instruments together in a band.

“Children love to sing. They are often sung lullabies in a normal home situation. Preschool and kindergarten. It's human nature to talk and sing. Kids like to show off. This is good [i.e. positive] attention.”

Human Body as an Instrument. Tongue, teeth and lips . . . everybody's build differently. Unique capacity for air and breath. Jaw has to move, sinus cavities, and bones. Vocal folds come together and vibrate—middle—lower—mid C—about 800 times per second. The higher you go, it's even faster . . . 1000 times per second. It's just like stringed instruments.

Music and Learning

Most direct contact to our brain is through the ear, through music- the music goes very direct to the nerves for learning.

Learning to sing verses just listening to music.

“Active in music, singing is like playing an instrument—when the instrument and how you learn to use it. Control it. Vibrations are inside of you—inside of the bones (you are your instrument).”

When these events occur, it's best NOT to sing:

Mucus makes the sound raspy—possibly nodes are on the vocal folds. Nodes can make the voice sound hoarse, may even be swelling—mucus.

Voice takes time to develop; it squeaks with men and children during puberty. Don't overstress them and force them to do thing they're not ready for. Not mature enough. If pushed too fast and too hard. Kids are imitating music. Forcing voices in one area instead of exploring, leading to vocal.

Belting—too much tension, singing like a man.

Screaming equals hoarse voice, too much stress; they need time to recover.

Sore throats—don't sing.

It is recommended that teachers control the songs from which the children choose in order to avoid the too big voice, belting issue discussed above. It would not be recommended to have an Arrias from an Opera song to the children or novices. Too much for the students' capability of doing it correctly. Demanding to sustain it; good deal of time to heal.

Recommended to test the abilities of the child prior to starting this program or any singing program. Inquire their age, and if they have had lessons. Test voices out—their octave range.

If you choose not to use a Karaoke machine, then provide song sheets—lyrics and play music.

Similar to the Italian Opera, the words could be written out and played on the screen, using a Karaoke machine, can also use foreign songs and include English subtitles. (Frere Jacques, for example).

The Voice box is connected to the cartilage. (Pg. 50 and 51.) Must take a breath in order for the vocal folds to vibrate.

The lungs, diagram to use air efficiently, muscles—ribs intercostals muscles. Costal breathing chest expands—rib position changes breathing. It's automatic, but this is what happens when you're singing. Good posture in singing, the lung capacity expands. A beautiful alignment of the spine. Cricoids muscles, all doing their own thing—pictures with speech. Enlarge whole aspect of speech. Freedom of jaw and posture little maucle changes. The pitch from high to low. Jaw too tight, not singing as well.

Health aspect, singing is good for overall body—posture—deep breaths. Oxygen going through the brain, attached to the ground—whole body linked.

“SINGING the Mechanism and the Technique, by William Vennard Revised Edition, copyright 1967

Pg. 16 The Voice as an Instrument: Three specific areas . . . note (60) The voice, (62) lungs and breathing,(correct inhalation and exhalation. Chapter 2, Breathing, note (72) and (64) if the throat and mouth are shaped correctly creates a sympathetic resonance. (67) Position of the tongue, on the soft pallet. Posture Chapter 2, Pg 19, Breathing.

(79) Before trying to play any instrument one should learn how to hold it. vocally this means posture. The head, chest, and pelvis should be supported by the spine in such a way that they align themselves one under the other—head erect, chest high, pelvis tipped so that the “tail is tucked in.” The position of the head should allow the jaw to be free, not pulled back into the throat. This liberates the organs in the neck. The high chest implies that the shoulders go back, but they should relax and be comfortable. There should be no straining like a solder on parade. A certain amount of tonicity of the abdominal muscles will be needed to keep the pelvis upright, but there must not be so much that deep breathing is impossible. This aspect of posture should be ignored if it prevents abdominal breathing.

Research to Explain How Eating Protein Benefits Learning and Memory

The following research can be found at The Franklin Institute, Resources for Science Learning, The Human Brain at www.fi.edu/learn/brain/proteins.html.

Nourish—Proteins. Ever since ancient sea anemones first emerged a half-billion years ago, amino acids have moved in the minds of all Earth's creatures. They allowed animals to emerge from the sea and thoughts to emerge from the brain.

Most neurotransmitters are made from amino acids obtained from the protein in food you consume. Neurotransmitters are the brain chemicals that motivate, focus . . . and sedate.

Amino acids that come from the protein you eat are the building blocks of your brain's network. Amino acids can excite or calm your brain as well as nourish your brain . . .

The amino acids tyrosine and tryptophan must both cross the blood-brain barrier in the same pathway. If tryptophan crosses the barrier it will have a calming effect. If tyrosine wins out, then you will be energized and alert.

One can be energized for hours after a morning meal high in protein, because it raises tyrosine levels in the blood and brain—causing neurons to manufacture norepinephrine and dopamine, two neurotransmitters that promote alertness and activity.

A high-carbohydrate meal can increase the brain's tryptophan levels, and hence the serotonin that promotes contentment and normal sleep.

Protein Connects the Developing Brain. Protein's networking role is even more dramatic and direct in the developing brain, when nerve cells are migrating from their birthplace. One particular protein acts as a molecule guide, somewhat like a dog herding a flock of sheep. It directs migrating nerve cells to their correct locations, where they link up with each other as they settle in. This protein guides the cell bodies themselves, as well as the growth of the long axons that extend from nerve cell bodies toward other nerve cells.

Nourish Your Brain with Amino Acids. . . . Fortunately, your brain can quickly respond to proper nutrition—even from a single meal. Amino acids are the building blocks of proteins. Your body breaks down dietary protein into the amino acids it uses to assemble the 50,000 different proteins it needs to function—including neurotransmitters and chromosomes, hormones and enzymes.

Dietary proteins fall into two groups. Complete proteins contain ample amounts of all eight essential amino acids. Fish and meat, fowl and eggs, cheese and yogurt are complete proteins. On the other hand, grains and legumes, seeds and nuts, and a variety of other foods are incomplete proteins, because they provide only some of the essential amino acids.

You can, however, combine different incomplete proteins to obtain all necessary amino acids. Such complementary proteins have been known for centuries and are part of the traditional diets around the world. For example, rice and beans combine to make a complete protein.

Eat foods that provide the full spectrum of amino acids your brain needs for an appropriate harmony of energizing and calming neurotransmitters. . . . Ensuring adequate neurotransmitter levels is crucial for optimal brain health and fitness. However, poor nutrition is not the only obstacle. Stress . . . tends to diminish neurotransmitter levels . . .

One of the most vulnerable key neurotransmitters, dopamine levels are depleted by stress or poor sleep. . . . Caffeine and sugar seem to diminish dopamine activity in the brain. It's also easily oxidized, therefore eat plenty of fruits and vegetables, whose antioxidants help protect dopamine-using neurons from free radical damage. More and more healthcare professionals recommend supplementing with vitamins C and E and other antioxidants to synthesize dopamine, which is crucial to fine muscle coordination. Attention deficits are also connected to dopamine.

Norepinephrine, also called noradrenalin, is the primary excitatory neurotransmitter needed for motivation, alertness, and concentration. Like a hormone, it travels in the bloodstream to arouse brain activity with its adrenalin-like effects.

Your brain requires norepinephrine to form new memories and to transfer them to long-term storage. This neurotransmitter also influences your metabolic rate.

Both norepinephrine and dopamine are manufactured from the amino acids tyrosine or phenylalanine in the presence of adequate oxygen, vitamins B3, B6 and C, folic acid, iron, and copper. Food sources of tyrosine include almonds, avocados, bananas, dairy products, lima beans, pumpkin seeds, and sesame seeds.

Serotonin. Serotonin is the calming neurotransmitter important to the maintenance of good mood. It promotes contentment and is responsible for normal sleep. In addition to the central nervous system, serotonin is also found in the walls of the intestine (the enteric nervous system) and in platelet cells that promote blood clotting.

Serotonin plays an important role in regulating memory, learning, and blood pressure, as well as appetite and body temperature. Low serotonin levels produce insomnia and depression, aggressive behavior and increased sensitivity to pain . . .

Serotonin is synthesized from tryptophan in the presence of adequate vitamins B1, B3, B6, and folic acid. The best food sources of tryptophan include brown rice, cottage cheese, meat, peanuts, and sesame seeds.

“The Health Benefits of Sunflower Seeds” Jan. 21, 2010 fatchicks.com

“Sunflower seeds are also a good snack to include. They contain tryptophan and choline. Tryptophan reduces stress, anxiety and depression and the choline appears to help increase brain function and improve memory.

Science at a Distance, by Brother Gregory, found at: www.brooklyn.cuny.edu/bc/ahp/AVC/MacroInv/Protein

“Proteins are involved in almost all aspects of cellular life and structure. They are also critical players in holding cells together into multicellular structures (like us!), and making sure that chemical reactions take place at “life speed”.

“Proteins are one of the four major groups of macromolecules that are found in all living organisms. These giant molecules carry out many of the vital functions needed by cells.”

“As with all macromolecules, proteins are polymers, composed of smaller subunits—the amino acids—joined together in long chains.”

Research Supporting Use of Silence In Learning

“Meditation For Kids: Parents Turn to Mindfulness Practices To Help Children Stay Calm” The Huffington Post (May 23, 2013)

“. . . research has also shown school mindfulness programs to be effective in reducing symptoms of depression and anxiety among adolescents.”

“The educational benefits of relaxation practices are also significant: Mindfulness meditating can improve focus and increase test scores. A University of California study published this year found that undergraduates who participated in a two-week mindfulness training program demonstrated heightened working memory and improved reading-comprehension scores on the GRE.”

“Meditating helps students get better grades” Telegraph.co.uk. Apr. 12, 2013

“They also found students who meditated before classes were able to focus better and concentrate for longer. . . . younger students who struggle to concentrate could benefit more from meditation.”

“Learning in the Classroom” US Committee for Stress-Free Schools.

“The alarming rise of classroom stress fuels widespread problems in education, including poor achievement, anxiety, depression, school violence, and teacher burnout. To help neutralize this stress, many schools are establishing a “Quiet Time” period at the start and end of each school day-two 10-15 minute sessions when students sit quietly to rest and/or read silently.”

### IMPLEMENTATION OF THE SYSTEM AND METHOD

While the benefits of exercise, diet, rest and even music in the process of learning have been recognized, to date there has been no recognition of the synergetic effect of combining these activities as described herein. The unexpected boost in learning resulting from the novel combination of these activities as described in the present disclosure has not been recognized prior to now.

In one representative implementation, the system includes a protein based food, an exercise regime, at least one song, instructions for implementing a combination of eating the protein-based food, exercising using the exercise regime, and singing the at least one song. The instructions can include exercising in place for five minutes, singing the song, sitting in silence; and eating the protein-based food. A workbook is provided that includes exercises that aid students in developing self-identity, self-esteem, and that helps students to recognize common traits with other students, as described below. The program of the present disclosure can be implemented in the classroom, through on-line courses via lectures, seminars, paper, or on a CD-ROM, DVD, as well as over a network of computers. This program is designed for students in the range of four years to 18 years, and it can be modified to accommodate students of any age by varying intensity, duration, and type of activity as described more fully below.

Overview of a representative embodiment of the method:

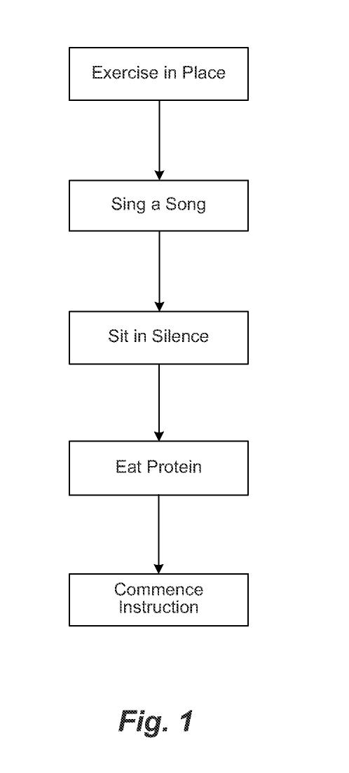

A fifteen minute program for increasing learning is described below and illustrated in FIG. 1. This program can be done individually, such as through one-on-one instruction or via prerecorded instructions or via live audio-video or a combination of one or more of the foregoing. Although the preferred length of time is fifteen minutes, it is to be understood that the length of time can be varied to accommodate special needs, large groups, foreign language issues, and the like. In one aspect of the present disclosure, the program can vary in length between 3 minutes and 50 minutes, which can be accomplished by varying the length of one or more steps of the program, as described more fully below or by eliminating one or more steps or reordering the steps. However, when more steps are included, the program will be more effective. Students on medication or with other special needs and accommodations should be individually evaluated by the teacher or instructor to ensure their participation in the program will be beneficial to them and not interfere with other students in the program.

The instructor may choose any one of the following four steps, if he/she's short of time and cannot schedule the full program due to lack of funding for equipment purchase. The students will still derive benefits to assist in the learning process. The instructor may also choose to rotate the steps, using a different step each day if he/she wants to allocate more time to each step.

### Step 1: Exercise

Exercise in place for five minutes. Exercises include, without limitation, running in place, jumping jacks and dancing. Ideally the exercises do not require movement around the classroom but instead are done while sitting or standing in place. Students with special needs can be accommodated by varying the length of the exercise from two minutes to five minutes. Ideally, for students without special needs, the length of the exercise portion can vary from three minutes to five minutes. No special clothes need be worn for this portion of the program and sweat towels or after-exercise showering are not necessary because the exercise should not cause the student to break a sweat. Students can monitor their heart rate using well known and commercially available devices as an indicator of the appropriate level of exercise. Ideally, the student heart rate will be in the range of 100 bpm to 170 bmp, depending on age.

### Step 2: Sing a Song

Sing a song together for three to four minutes. It would be best to use a foreign language song. One option is to have students think of the words in their native language as they sing. Preferably, the song should be written in a key that is in the group's voice range. No excessively high or low notes should be used in order to avoid straining the voice. Songs should have lyrics and a tune that is easily learned and memorized without requiring the ability to read music. Prerecorded music with or without the vocals can be used or live musical instruments can be used by the students to enhance the incorporation of music into the program.

### Step 3: Silence

Sit in silence for one minute. The silent step can last up to 50 minutes, although this length of time would likely be suitable for special programs. Students can sit cross legged or upright in a chair and relax. Special needs students can use aids such as wheelchairs as needed. There should be no music, speaking, chanting, loud breathing, or other noise from the students or the environment. Headsets and ear pieces to enable students to listen to relaxing sounds may be used. Curtains or blinds can be drawn over windows and windows can be closed to reduce outside light and noise and provide a serene and relaxing atmosphere. Students should be encouraged to clear their minds and release any stressful thoughts or anxieties. However, students should not be allowed to doze off, sleep, or nap unless their needs require otherwise.

### Step 4: Eat a Protein Snack

The snack must contain a minimum of eight grams of protein. Allow five minutes for the student or group of students to eat their snacks. Students with dietary restrictions should be evaluated for participation in this aspect of the program. Students may eat together at a common table or tables or eat at their individual desks or stations. Water or other liquid can be provided. If necessary, students or participants can take time to wash their hands and faces before resuming the program. Brushing of teeth can also be done, and adequate time should be allotted.

Step 5: Commence the training session

The instructor or teacher then begins the instruction or lesson portion of the program. Preferably the instruction or lesson portion takes place at the same place where the student has been exercising, singing, sitting silent, and eating. During the instruction, students should be focused on the lesson without distraction from food or liquid, although water can be provided to the students in water bottles as needed.

It is to be understood that the instructor may vary the program in accordance with the needs of the students and the constraints of the program sponsor and the facilities. If the exercise step is chosen to be the only brain booster of the day, the teacher can choose to have the class run or jog in place for three minutes, or run or jog outside for a longer duration. He/She may choose to have the class play an active game, such as dodge ball, basketball, soccer, or kickball.

If the singing step is chosen, and the instructor wants to use this step for a longer period of time, he/she can choose simple songs, provide song sheets, and the class can learn the song together. Learning a foreign song would derive more benefits, but learning a simple song will also make a difference. Choosing a shorter song, or one which the class knows well, also accomplishes the smaller time frame of three to five minutes.

The silent moment, or minutes, is used to turn a chaotic or non-listening group into one of calm and attentiveness. Again, the teacher can choose the most appropriate time to use this step. While sitting, they can listen to music, chant, but they cannot sleep. They may wear headphones or use ear plugs. They may be provided one word to chant or think about quietly, such as thinking of the word “relaxed” or “calm”.

The protein snack step can also be lengthened. The instructor may choose to provide an entire meal for this period of time. He/she may have the class prepare it, eat it, and clean it up.

The exercise and singing steps can be done in either order. Eating the protein snack should be the step after all the activities, as it might upset the stomach to do it prior to exercising or may change the vocal resonance.

The benefits of the foregoing program and system of learning includes enhanced brain activity, increased attention span, greater focus on the present learning task, and higher retention of what is being taught. This is confirmed objectively via comparative testing of students as well as subjectively through observation and student feedback.

### Prevention of Bullying

The following is additional material to aid teachers in stopping or preventing bullying in the classroom and on school grounds. It is intended to be an addition to the My World teaching manual and includes the My World Workbook, described in detail below.

In light of the recent shootings in elementary schools; nine year olds bringing guns to school and killing their classmates. My World may be a resource to prevent gang behaviors, bullying and allow children to reach their full potential.

My World allows children to say no to peer pressure:

“I feel good about myself because I was given support and recognition for a job well done the last time I tried something, therefore, I will try this new experience or activity.”

This helps the autonomous feelings of saying no to peer pressure:

“Just because everyone else is looking at the picture of Rebecca being forced to kiss Jimmy, I'm not. I found out this morning that she and I like the same snake. ‘Hey Rebecca wait up—I want you to be my partner picking up litter—I can't believe you and I like the same snake—King Cobral! . . . did you know they spit?’”

My World helps children say no to peer pressure, mentoring autonomous feelings. The classmates create community projects together, like building a website or picking up litter in the playground. They are part of a team and continue to learn about the common threads amongst themselves. Each is proud of their accomplishments for contributing to the community.

Used by early child educators, My World builds the good feelings generated by positive self-esteem for children Preschool through second grade. During this age span, the teacher shares the role of “significant other” with the parent. The teacher, acting as a guide, builds upon what the parent has started.

Without a parental guide/mentor, after age ten, research has shown that there is more likelihood for children to move towards gang related behaviors/activities. One of the employees of Homeboy Industries, a former member of an L.A. gang, shared this street knowledge with me last February.

The My World identity program increases self worth by enabling children to recognize and embrace their talents and reach their true potential. Research indicates that positive self esteem motivates an individual to strive toward his or her innate potential. As many as 90% of prisoners are abused as children. When growing up, many of them did not receive positive encouragement and support from their parents and teachers. There is also a similar relationship with youth who are cruel to animals and abuse them. My World's program addresses the red flag of animal abuse and teaches good citizenship towards animals as well as others. The My World system helps to curb, evaporate and prevent gang leaders and gang peer pressure; it builds strengths and acknowledges each child's identity.

The My World system teaches good citizenship and eliminates gang mentality by being inclusive; it keeps children off the streets. Most people would agree that it's much easier to train rather than to retrain and try to change a bad habit or behavior. My World creates cohesive relationships by teaching children to work together on shared projects and recognizing commonalities. My World challenges children, rather than staying within limitations due to fear of failure created by noninvolvement. My World creates leaders who can inspire change.

The My World educational program helps students to see common threads in each other, which thus builds a unified community. For example, after participating in the My World program, a child may say “She/he is just like me. She's a different color, a different size, a different gender. She's wearing designer socks and

I've only got a second hand dress, but WE BOTH LIKE to dance to rap music. She's shorter than me, but she shared in class that she eats tofu too and now we're playing together at recess.”

Parent/teacher mentorships with children allow for better citizenship skills and a higher level of learning to occur. As a result of this parent/teacher commitment to the program, the children feel accepted, supported and worthy to reach a higher step. One that they may feel uncomfortable and unstable at first, but willing to try and achieve.

Using the My World program or system on a daily basis develops consistent positive feelings. The activities give the students something to look forward to, knowing they can have fun accomplishing lessons. The effects of these exercises should create a greater level of understanding and good feelings with the children amongst themselves, their fellow students, as well as the teachers with their students. The rest of the day's activities should build upon these good feelings. The daily activity of sharing the completed exercises also teaches the children communication and interaction skills.

### Directions for Use:

The following instructions are meant as a guide for the teacher. The teacher has the flexibility to choose those activities that fit into the daily lesson, fulfilling the curriculum goals.

Each week have the child, with the help of the parent, complete one page from the My World Workbook (described more fully below). Then, have the students share their completed exercises every morning in a round robin style.

Preparation for Class Participation: Exercise, Singing and Protein First Fifteen Minutes.

Research shows that exercising, singing and consuming protein increase the ability to learn and develop better memorization skills. Every morning the first fifteen minutes can be used to increase brain power.

The kids can gather around in a circle:
1. Ask them to exercise in place for a few minutes, such as jumping jacks, running in place, or dancing. Each child may take turns choosing their favorite exercise and music.
2. Next, sing karaoke to one of the children's favorite song. A different child chooses each day.
3. Lastly, protein snacks may be eaten.

Class participation:

Class size, number of teachers, and attention span of the children will determine the teaching style. Some styles include:
1. Choose three to four students each morning to share their assignments with the class.
2. Break the class into three to four groups. Each group is facilitated by a teacher or assistant. Each child shares his or her exercise with the group.
3. Assign independent time for the class. Choose five to six children at a time to share and discuss their exercises.

Positive statements and feelings also assist with continued excellence. A child is chosen daily, and the teacher and class collectively highlight the child's strengths in front of the group.

Encourage and support each child by having the rest of the class applaud, ask questions, and listen attentively. If the answers are repetitive, have a show of hands to see how many others have the same answers, then move on to the discussion or another activity. Limit the time spent sharing to ensure everyone gets a turn. After the students have shared, start a class discussion relating to the daily topic. Group the children together after discovering their classmates same common interests. Have the classmates with similar interests for the daily exercise work on a project together.

Discussion ideas for each activity are included in this manual. The discussion may last one day or two weeks, depending upon the unit being studied.

Some activities which are springboards for lessons include: birthdays, family, houses, pet, friends, colors, and food. A list of curriculum resources for these topics is included in this packet. Classroom projects are also included in the exercises.

The teacher may not feel some of the activities are appropriate, warrant class discussion, or are difficult concepts for the children to learn in a group format. My World is only a starting point.

Please expand upon the list of activities and include this daily exercise throughout the school year.

### Recommended Curriculum Resources:

Themestroming: by Joni Becker, Karen Reid, Pat Steinhause, Gryphon House

Story Stretchers: by Shirley C. Raines, Gryphon House

More Story Stretchers: by Shirley C. Raines, Gryphon House

Creative Resources for the Early Childhood Classroom 4th Edition: Judy Herr and Yvonne Libby Larson, Delmar Publishers

Feed the World: A leadership class project written by Bagley Elementary Fifth grade class in Seattle, WA. PGW.com (9780983661504).

### Sample Parental Participation Request Letter

“Dear Parent(s):

“I believe children benefit from working with parents on projects to eliminate bullying and prevent gang peer pressure. This is our goal. For this reason I am sending home a scrapbook keepsake, which will be worked on by you and your child through the year. The book is an identity tool, about everything which encompasses your child's world which is important to him or her:

“Birthday, family, friends, pet, house, food, color, etc.

“The book will be used as a springboard to teach units on these subjects as well as a self-history book to be cherished.

“Taking into consideration your busy schedule, the assignments are to be completed on a weekly basis. The children will be taking the completed exercises to class and sharing their work throughout the week. They will also be completing shared projects with shared responsibilities which are related to these homework assignments.

“Please set up a time on a regular basis to work with your child. It is my intention that this project be educational and fun for everyone. I will be phoning to discuss this project with you.

“Thank you for your cooperation.”

### Suggested Activities for the my World Program

### The my World Workbook

Below is a summary description of each page of the My World

Workbook exercises and activities. Following the summary description is sample text used in the My World Workbook.

#1—Page 1: Name of child—Identity Building

Exercise 1: A) Send instructions for this project home with child. Explain how the parents' interaction with the child will help make this assignment a success. Each exercise requires the parent to assist the child in thinking about a personal story related to each topic. B) Find picture of child, if no picture is available, use the camera on cell phone. Have child print his or her name in book. Think of one trait or talent that is unique to the child.

Each Child Shares: Child shares picture and one talent or trait.

Classroom Discussion: Talk about how books are printed, E-books, and websites. Discuss what authors and illustrators do and how the students are authors when completing this book.

#2—Page 3: Child with “Sketch” and “Bouncer”

Exercise 2: Child draws self using his or her special talents with the characters.

Sharing: Child shares the drawing.

Discussion: Introduction of the characters “Sketch” and “Bouncer.” These characters will be guiding the child through the exercises to complete his or her book. Discuss the instructions for creating this book, the materials required to complete the exercises and how the parents will be assisting the child.

#3—Page 4: Child's Birthday

Exercise 3: Child writes age and date of birth. Parent assists child in completing a short synopsis surrounding the event of the child's birth.

Sharing: Child shares experience with class.

Discussion: Discuss pregnancy, hospitals and birth. Have they seen someone special to them pregnant? What happened when the new baby was brought home?

#4—Page 6: Family

Exercise 4: Child draws his or her family. Discuss the family's favorite activity.

Sharing: Each child shares the drawing and talks about his or her immediate family.

Discussion: Discuss the fact that we all don't live with both parents, have more than one sibling, and may have an adult other than our biological parents raising us. Other possibilities for discussion include adoption, having step-parents, step-brothers and sisters.

#5—Page 8: Family History

Exercise 5: Child talks about his or her grandparents, parents and siblings. He or she share family origin.

Sharing: Child talks about his or her grandparents, parents and siblings. He or she shares family origin.

Discussion: Discuss how it was different for the child's parent growing up with his or her grandparents. What were some of the conveniences we have today that our grandparents never had? i.e. none or limited computers, video games, DVD's, IPODs, cell phones.

#6—Page 10: House—Goal Setting and Safety

Exercise 6: Fill in address and phone number. Child draws a picture of residence or one he or where she would like to live. Discuss child's favorite room in the house.

Sharing: Child shares drawing of house and favorite room.

Discussion: Discuss the different residences, such as apartments, condos, townhomes and houses. This is where I live presently, this is my dream house.

Home and phone safety: Never to share with solicitors parents are not home. When to allow calls to go to voice mail. Talk about safety issues concerning students i.e. to look both ways before crossing the street; not to accept rides from strangers, nor to talk to strangers. Utilizing the buddy system when walking home.

#7—Page 12: Map—Skill development

Exercise 7: Child colors in the states he or she has lived, visited or currently resides. Learn how to read GPS and maps.

Discuss what characteristics the child likes best about these locations. Each child brings one historical story about the area they live. It can be in a neighborhood, city or state. For example, the story can be about picking blackberries if they live in the Pacific Northwest where the berries grow wild, and making a blackberry pie.

#8—Page 14: Pet—Good Citizenship

Exercise 8: Child draws or finds picture of favorite pet or one they would like to own. Think of an experience the child had with the family pet, create a story with the pet or one the child would like to own.

Sharing: Child shows picture or drawing and tells a story about the pet.

Discussion: Care of pets: feeding, cleaning cages or litter boxes, bathing, taking time for walk pet. Pet commitments: responsibility to them for the rest of their lives. What happens to a pet when the family goes on vacation: kennels, a neighbor is asked to feed, etc. Classroom may adopt a pet, such as a gerbil or hamster, or put together a pet show. Field trip to pet rescue or have a staff member bring a lost/abused pet and discuss what happens when people don't take care of their animals, how they can help and adopt a rescue animal. Discuss cruelty or abuse towards animals.

#9—Page 16: Books- Skill Development—Goal Setting

Exercise 9: Child writes names of favorite books and brings them to school. Discuss synopsis of the books.

Sharing: Child names and displays favorite books, giving a brief description.

Discussion: Talk about what makes a book our favorite: favorite characters, type of story, happy ending etc. Setting goals for future: We're college bound. Reading for excellence contest. Award the students for most number of books read over a month. They include a short synopsis and are awarded a protein treat.

#10—Page 18: Favorite Character- Good Citizenship

Exercise 10: Child draws a picture of favorite character from TV or the movies. Create child's own show: i.e. “A Life in the Day of ______”

Sharing: Child discusses favorite character and shares his or her own show.

Discussion: Talk about what makes a character our favorite: Are the characters funny, good virtues, exemplary citizens, or share things in common with us or what we'd like to emanate?

#11—Page 20 Activity—Good Citizenship—Safety

Exercise 11: Child writes and draws his or her favorite activity i.e. riding bikes, drawing, jumping rope, website interactive activities, I-phone, I-pod etc. Discuss how the child discovered this activity and what makes the activity fun. Sharing: Child shares favorite activity, how he or she first discovered this activity and what makes it so much fun.

Discussion: Helmet safety. Safety on the playground. Good citizenship behavior. Receive an blue ribbon award on Monday from the following week, for the best behavior in class and at recess.

Activity: Group children together who like similar activities. Allow them to participate in the activity.

#12—Page 22 Games—Good Citizenship

Exercise 12: Child writes and draws his or her favorite game. What makes this game so much fun to play?

Sharing: Child shares favorite game and what he or she likes best about it.

Discussion: Playing by the rules and the consequences if they choose not to do so.

Activity: Play a game with the entire class.

#13—Page 24 Songs—Skill Development

Exercise 13: Child writes names of favorite songs and bring the lyrics or CDs to class.

Discuss why these songs are special to the child.

Sharing: Child shares favorite songs and why he or she chose them.

Activity: Class sings the songs. Class writes lyrics for a song and teacher invites composer to class. Perhaps the music teacher can do this or knows a composer who likes to work with children. Composer brings keyboards and creates composition during class. Each child gets a CD.

#14—Page 26 Toys—Skill Development

Exercise 14: Child writes and draws a picture of his or her favorite toy, creating a story using the toy. Child brings the toys to class.

Sharing child shares favorite toy and tells a story incorporating the toy.

Discussion: Have each child exchange toys with a partner and share his or her favorite playtime experience.

#15—Page 28: Favorite Colors—Building Community

Exercise 15: Child colors “Sketch” and “Bouncer” using favorite colors. Discuss what items the child owns that includes these colors. Child wears most favorite color to class.

Sharing: Child shares favorite colors and which items he or she owns that contains these colors.

Discussion: Group children together by their most favorite color. Today this group eats lunch together. All the single colors eat lunch with the teacher.

#16—Page 30: Friends—Building Citizenship- Preventing Bullying/Gang Peer Pressure

Exercise 16: Child writes names of best friends and draws a picture of them. Discuss why he or she likes each friend.

Sharing: Child shares drawing of friends, names them and what makes each friend special to the child.

Discussion: Discuss different types of friendships: teacher, fellow student, next door neighbor, uncle or scout leader. Strangers, people who may ask you to get in their car. What makes this person important to the child? What do they like to do together? Discuss boundaries with friends. Bully tactics: what to do in a warfare free zone. Uplifting those who have a bully demeanor—building bullies up using their strengths. Peer pressure, when you're alone at the back of the bus with a gang. How to turn a bully into a friend. When to tell on a bully. What to do in the event a friend confides in you about a bully situation. How to say “no.”

#17—Page 32 Foods—Nutrition

Exercise 17: Child writes and draws favorite breakfast food. Child brings this item to share and includes the recipe.

Sharing: Child names and shares favorite breakfast food.

Discussion: Discuss different food groups and the importance of eating healthy foods.

#18—Page 34: Eating Out/Restaurant Etiquette—Skill Development

Exercise 18—Child writes name of favorite restaurant or one where they'd like to go.

Sharing: Child names favorite restaurant and what he or she likes about it.

Discussion: Discuss dining etiquette and manners: the use of napkins, saying please when asking for foods to be passed and not placing elbows on the table, etc. What to do when people push you in the cafeteria line. What to do when people take “cuts” in line.

#19—Page 36: Ensemble—Skill Development

Exercise 19: Child draws favorite clothes that he or she enjoys wearing. Create a story encompassing what the child did when last wearing that outfit.

Sharing: Child wears favorite ensemble to class. Each child shares a story a favorite experience while wearing that outfit.

Discussion: What to wear to events, such as a basketball game, theatre, or a Charity Auction.

Color schemes: summer, winter, spring, or fall which correspond to our skin colors and hair.

#20—Page 38: Holidays—Building Community

Exercise 20: Child writes a story about Thanksgiving. Draws a related picture. Create story of the child's favorite holiday experience.

Sharing: Child shares drawing and story about his or her favorite Thanksgiving holiday.

Discussion: Discuss why we celebrate Thanksgiving. Class project: Volunteering to help a local food lifeline nonprofit charity. Learning to work together and the joy of helping others less fortunate than ourselves.

#21- Page 40: Vacations—Goal Setting—Hope for my future

Exercise 21: Child writes name of favorite place or one they'd like to go someday and draws picture of where he or she likes to visit. Create a story of child's last vacation.

Sharing: Child shares vacation spot and a special experience he or she had when visiting.

Discussion: Talk about the locations the class would like to visit, such as possible field trips or “make believe” destinations. Saving our allowance. Earning money. How the piggy bank grow if you start now. Bank representative discusses savings growth. Class determines field trip location and saves money together. Decides on way to earn the money for the field trip—such as a car wash.

#22 Page 42: Self-Discovery

Exercise 22: Parents review My World with child. The child decides which exercises and activities he or she liked best. Choose one to share with class. Discuss child's unique talent and how this can be further developed.

Sharing: Child shares what pages in My World were liked best. The child also shares his or her unique talent and how it will be developed.

Discussion: Talk about how all of us are unique. Each person has different gifts, which allows us to be important members of the TEAM.

Exemplar text for the workbook associated with the My World system follows:

### Page 1

MY WORLD WORKBOOK

Created by: ______

### Page 2

You'll need colored pencils, crayons, a pen, a few magazines, and photos of your family and friends. These will be used. to create your own scrapbook keepsake.

The lines in this book are to be filled out by the adult helping you. You can write and draw in the boxes and blank spaces.

(Illustration)

### Page 3

Draw Yourself:

### Page 4

Birthdays are special. We celebrate the day you were born.

(Illustration)

### Page 5

No one will ever forget the day I was born because: ______.

I am years old. I was born on

### Page 6

A family can be large or small. It can be just you and an adult, or it can be lots of people.

(Illustration)

### Page 7

This is my family:

### Page 8

Grandparents, parents, and children are all part of a family.

### Page 9

My grandparents' names: ______.

My parents' names: ______.

My brothers' and sisters' names: ______.

### Page 10

Homes come in all shapes and sizes.

(Illustration)

### Page 11

This is my home:

### Page 12

There are 50 states in the United States of America. One of them is yours.

Color the state you live in, the states you've visited and where you've lived before.

(Illustration)

### Page 13

I live in ______ city ______ state

(Illustration)

### Page 14

Pets are our animal friends. There are cats and dogs, fish and birds, hamsters and lizards . . .

(Illustration)

### Page 15

My pet's name is: ______

This is my pet or the one I would like to have someday:

(Illustration)

### Page 16

Books can take you to make-believe worlds or teach you about the world around you,

(Illustration)

### Page 17

My favorite books:

(Illustration)

### Page 18

Cartoon, TV, and movie characters are friends who entertain us in our homes or at the movie theater.

(Illustration)

### Page 19

My favorite TV show or movie is: ______

This is one of my favorite characters:

### Page 20

Activities include jumping rope, riding bikes, reading and drawing.

(Illustration)

### Page 21

Activities I love:

(Illustration)

### Page 22

Games like soccer, tag, computer and checkers are fun to play.

(Illustration)

### Page 23

My favorite games:

(Illustration)

### Page 24

Songs brighten your day. Singing makes you feel great!

(Illustration)

### Page 25

My favorite songs:

(Illustration)

### Page 26

Toys make playtime fun: stuffed animals, cars and building blocks . . .

(Illustration)

### Page 27

Some of my toys are: ______

This is my favorite toy:

(Illustration)

### Page 28

Colors make our world bright, bold and beautiful.

(Illustration)

### Page 29

My favorite color is:

(Illustration)

### Page 30

Friends are people who like you. They can be boys and girls, men and women.

(Illustration)

### Page 31

Some of my friends are: ______

This is my best friend:

(Illustration)

### Page 32

Breakfast, lunch, dinner and snacks—food gives us energy to work and play.

(Illustration)

### Page 33

My favorite foods:

(Illustration)

### Page 34

It's fun to eat out.

(Illustration)

### Page 35

My favorite places to eat:

(Illustration)

### Page 36

Jackets, shirts, pants, socks and shoes—our favorite outfits make us feel great!

(Illustration)

### Page 37

This is my favorite outfit:

### Page 38

Every holiday is a celebration!

(Illustration)

### Page 39

My favorite holiday: ______

I like it best because: ______

### Page 40

Vacations can be anywhere: visiting parks, relatives, museums, or zoos . . .

(Illustration)

### Page 41

My favorite places to visit:

(Illustration)

### Page 42

(Illustration)

### Page 43

What I like best about My World: ______

The illustrations referenced above can be color or black and white and can involve cartoon style illustrations with dialog between the characters that reinforces the text on the preceding page, following page, or same page. The characters in the illustrations may be licensed well-known characters or new characters appropriate for the audience.

By combining the previously described system with the prevention of bullying activities, students will realize increase learning, a change in behavior, and a recognition of their self-worth and appreciate and value the differences in those around them. Hence, it is expected that the prevention of bullying will be one of the learning activities to be engaged in after the student has participated in the program for increased learning. For example, a student will perform the steps of the program for increased learning, then work on the workbook and related activities for the prevention of bullying as described above.

The various embodiments described above can be combined to provide further embodiments. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of educating students, the method comprising the following steps in the order of:
exercising in place for five minutes;
singing a song without delay after the exercising;
sitting in silence immediately after the singing;
eating the protein-based food immediately after the sitting in silence; and
conducting a teaching or training session that includes at least one from among building personal self-worth, identity building, and esteem building.

2. The method of claim 1, wherein the conducting a teaching or training session comprises completing one or more lessons from a My World Workbook.

3. The method of claim 1, wherein the conducting a teaching or training session includes identifying similarities among other students in the teaching or training session.

4. A method of teaching, comprising:
providing a protein based food, an exercise regime, and at least one song;
implementing a combination of eating the protein-based food, exercising using the exercise regime, and singing the at least one song, including:
exercising in place for five minutes;
singing a song;
sitting in silence;
eating the protein-based food; and
commencing a teaching or training session.

5. The method of claim 4, wherein the exercise regime includes at least one from among running in place, jumping jacks and dancing.

6. The method of claim 4 wherein the exercising lasts for at least 5 minutes.

7. The method of claim 4, wherein the at least one song comprises a song that is in a non-native language.

8. The method of claim 7, wherein singing comprises thinking of the non-native language song in the native language while singing.

9. The method of claim 4 wherein the at least one song is written in a key that will not strain the voice.

10. The method of claim 4 wherein the singing includes singing for at least 3 to 4 minutes.

11. The method of claim 4 wherein the sitting in silence comprises sitting in silence for at least one minute.

12. The method of claim 4 wherein the sitting in silence comprises sitting in a relaxed condition and in one of a cross-legged position or in an upright chair.

13. The method of claim 4 wherein the protein-based food comprises a minimum of eight grams of protein.

14. The method of claim 4 wherein the eating comprises eating for at least 5 minutes.

15. The method of claim 4 wherein the teaching and training session comprises a course of instruction in the prevention of bullying.

16. A system for educating students, comprising:
a protein based food;
an exercise regime;
at least one song;
instructions for implementing a combination of eating the protein-based food, exercising using the exercise regime, and singing the at least one song, that include instructions for exercising in place for five minutes, singing the song, sitting in silence; and eating the protein-based food; and
a workbook comprising exercises that aid students in developing self-identity, self-esteem, and that helps students to recognize common traits with other students.

17. The system of claim 15 in which the instructions and the workbook are provided in a digital format over a network of computers.

18. The system of claim 16 in which the workbook is directed to the prevention of bullying.
